(19) United States
(12) Patent Application Publication
(10) Pub. No.: US 2015/0103205 A1
(43) Pub. Date: Apr. 16, 2015

(54) METHOD OF CONTROLLING DIGITAL APPARATUS AND IMAGE CAPTURE METHOD BY RECOGNITION OF HAND SHAPE, AND APPARATUS THEREFOR

(71) Applicant: Samsung Electronics Co., Ltd., Suwon-si (KR)

(72) Inventors: Sung-do CHOI, Suwon-si (KR); Seong-oh LEE, Yongin-si (KR); Moon-sik JEONG, Seongnam-si (KR); Hyeon-hee CHA, Suwon-si (KR)

(21) Appl. No.: 14/513,790

(22) Filed: Oct. 14, 2014

(30) Foreign Application Priority Data
Oct. 14, 2013 (KR) 10-2013-0122221

(51) Int. Cl. H04N 5/232; G06F 3/01; G06K 9/00

(52) U.S. Cl. CPC H04N 5/23219; H04N 5/23216; G06K 9/00355; G06F 3/017
USPC 348/231.6; 348/222.1

(57) ABSTRACT

A digital apparatus is provided. The digital apparatus includes an image acquisition unit configured to acquire an image of a user and a controller configured to recognize a hand shape in the acquired image of the user and to perform a function corresponding to the recognized hand shape.

### CROSS-REFERENCE TO RELATED APPLICATION(S)

This application claims the benefit under 35 U.S.C. §119(a) of a Korean patent application filed on Oct. 14, 2013 in the Korean Intellectual Property Office and assigned Serial number 10-2013-0122221, the entire disclosure of which is hereby incorporated by reference.

### TECHNICAL FIELD

The present disclosure relates to a method of controlling a digital apparatus based on a recognized hand shape, a method of capturing an image in a digital camera based on a recognized hand shape, and an apparatus therefor.

### BACKGROUND

Digital apparatuses which include cameras and operate based on user gestures have been used. Since the digital apparatuses are controlled by a method in accordance with gestures which are determined based on motions of a user, the users' arms often become fatigued. Also, in the case of the gestures determined based on the motions of the user, background motions other than the motions of the user can affect the determination of the intended gestures, and thus, malfunction of a digital apparatus frequently occurs because the digital apparatus reacts to movements of a user or object other than the user who controls the apparatus. That is, there is a high possibility in which the apparatus may operate incorrectly due to determining unintended gestures.

In addition, when the user takes a self-portrait by using a digital camera or a portable device including a digital camera, the digital camera or the portable device may be unsteady when the user presses a button to capture the image, and thus a resolution of the self-portrait image may be low.

Therefore, a method of using a user interface is necessary to control digital apparatuses or digital cameras.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of controlling a digital apparatus based on a recognized hand shape, a method of capturing an image, and an apparatus therefor, in order to solve the above problems.

Additional aspects will be set forth in part in the description which follows and, in part, will be apparent from the description, or may be learned by practice of the presented embodiments.

In accordance with an aspect of the present disclosure, a digital apparatus is provided. The digital apparatus includes an image acquisition unit configured to acquire an image of a user and a controller configured to recognize a hand shape in the acquired image of the user and to perform a function corresponding to the recognized hand shape.

In accordance with another aspect of the present disclosure, a method of controlling a digital apparatus is provided. The method includes acquiring an image of a user, recognizing a hand shape in the acquired image of the user, and performing a function corresponding to the recognized hand shape.

In accordance with another aspect of the present disclosure, a digital camera apparatus is provided. The digital camera apparatus includes a capturing unit configured to capture an image and a controller configured to recognize a hand shape in a preview image acquired by the capturing unit and to control the capturing unit to capture the image if the recognized hand shape includes a predetermined hand shape.

In accordance with another aspect of the present disclosure, a method of capturing an image in a digital camera apparatus is provided. The method includes acquiring a preview image, recognizing a hand shape in the acquired preview image, and capturing an image if the recognized hand shape includes a predetermined hand shape.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a digital camera apparatus according to an embodiment of the present disclosure;

FIG. 2 is a flowchart of a method of capturing an image according to an embodiment of the present disclosure;

FIG. 3 shows hand shapes according to an embodiment of the present disclosure;

FIG. 4 illustrates a method of capturing an image, according to an embodiment of the present disclosure;

FIG. 5 is a diagram of settings of hand shapes of each user, according to an embodiment of the present disclosure;

FIG. 6 is a block diagram of a digital apparatus according to an embodiment of the present disclosure;

FIG. 7 is a flowchart of a method of controlling a digital apparatus according to an embodiment of the present disclosure;

FIG. 8 illustrates ok gestures according to an embodiment of the present disclosure;

FIG. 9 is a flowchart of a method of recognizing hand shapes according to an embodiment of the present disclosure;

FIG. 10A illustrates a method of recognizing hand shapes according to an embodiment of the present disclosure;

FIG. 10B illustrates a method of recognizing hand shapes according to another embodiment of the present disclosure; and

FIGS. 11A and 11B illustrate a method of recognizing ok gestures according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the specification, when a portion “includes” an element, another element may be further included, rather than excluding the existence of the other element, unless otherwise described. Also, the terms “unit”, “module”, etc. are units for processing at least one function or operation and may be implemented as hardware, software, or a combination of hardware and software.

The present disclosure will now be described more fully with reference to the accompanying drawings, in which various embodiments of the disclosure are shown. The disclosure may, however, be embodied in many different forms and should not be construed as being limited to the various embodiments set forth herein; rather, these various embodiments are provided so that this disclosure will be thorough and complete, and will fully convey the concept of the disclosure to those skilled in the art. Like reference numerals in the drawings denote like elements.

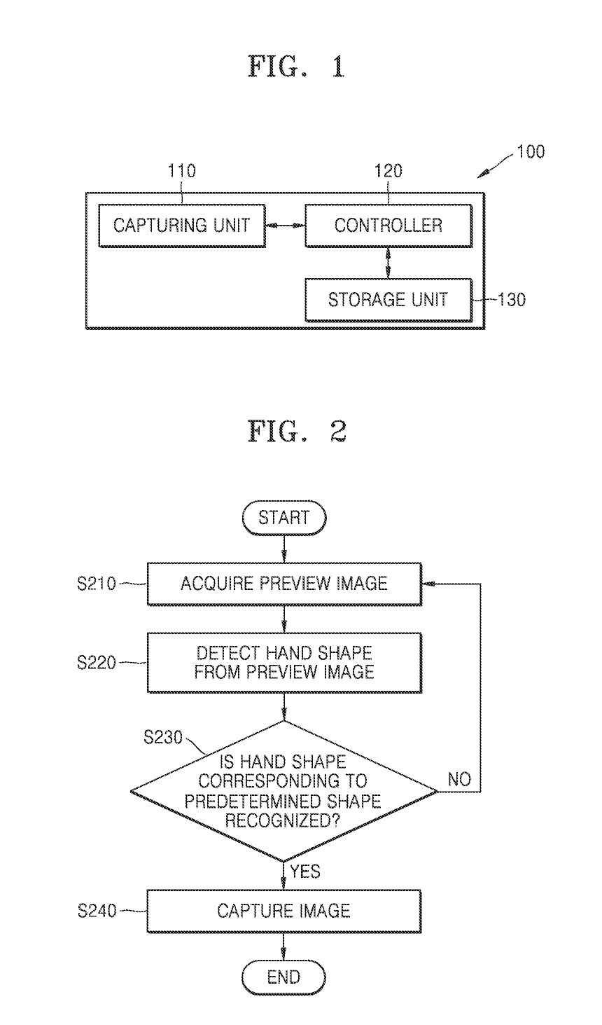

FIG. 1 is a block diagram of a digital camera apparatus 100 according to an embodiment of the present disclosure.

Referring to FIG. 1, the digital camera apparatus 100 may include a capturing unit 110, a controller 120, and a storage unit 130.

The capturing unit 110 is configured to capture an image and output the captured image to the controller 120, and acquires a preview image and outputs the acquired preview image to the controller 120. The controller 120 is configured to recognize a hand shape from the preview image acquired by the capturing unit 110 and may be embodied as a processor. Also, the controller 120 may include a classifier which is embodied by software and/or hardware. If the recognized hand shape corresponds to a predetermined shape which is determined by a manufacturer or a user, the controller 120 controls the capturing unit 110 to capture an image. The storage unit 130 stores images captured by the capturing unit 110.

If an image is captured at a point in time when a certain hand shape is recognized from the preview image, a posture, which is taken by the user to order the capture the image, is intactly captured, and thus the controller 120 may control the capturing unit 110 to capture the image when a certain amount of time passes after the predetermined hand shape included in the preview image is recognized. A counter may be used to determine whether the certain amount of time has passed and may be embodied by software or hardware.

FIG. 2 is a flowchart of a method of capturing an image according to an embodiment of the present disclosure.

A preview image is acquired in operation S210, and a hand shape included in the preview image is detected after the preview image is analyzed in operation S220. If a predetermined hand shape is recognized from the preview image in operation S230, an image is captured in operation S240.

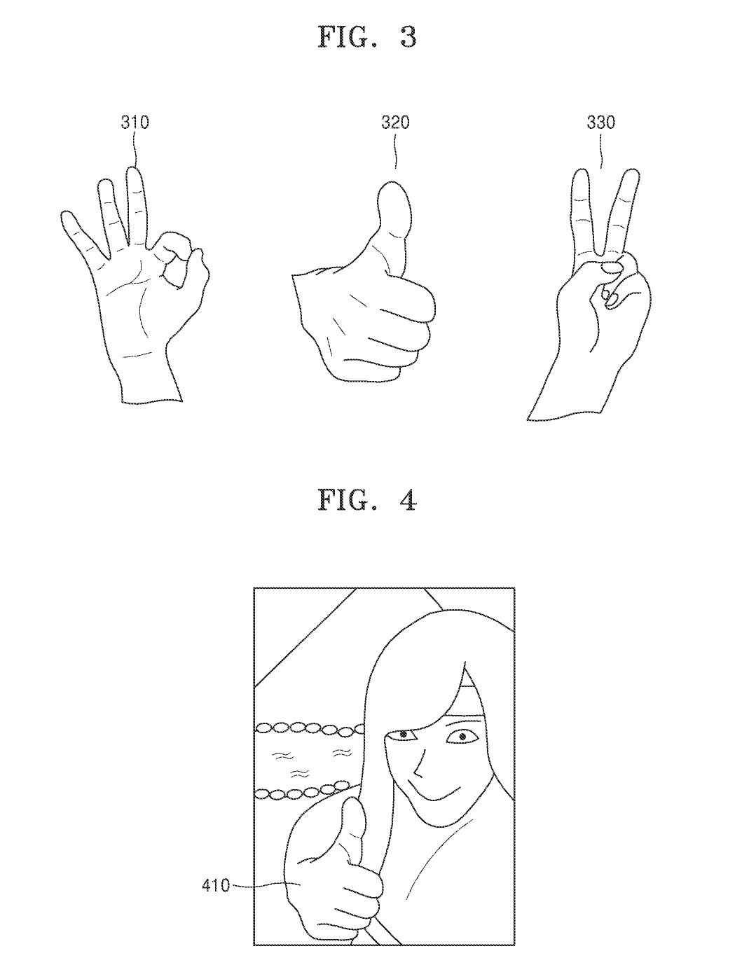

FIG. 3 shows various hand shapes according to an embodiment of the present disclosure.

An ‘Okay’ gesture 310, a thumbs-up gesture 320, a ‘V’ gesture 330, etc. may be hand shapes used to initiate an image capture. However, the hand shapes are not limited thereto, and other hand shapes may be used as well.

FIG. 4 illustrates a method of capturing an image, according to an embodiment of the present disclosure.

Referring to FIGS. 1 and 4, the preview image acquired by the capturing unit 110 includes a hand holding the thumb up, and the controller 120 recognizes a hand image 410 corresponding to a thumbs-up posture from the preview image and controls the capturing unit 110 to capture an image.

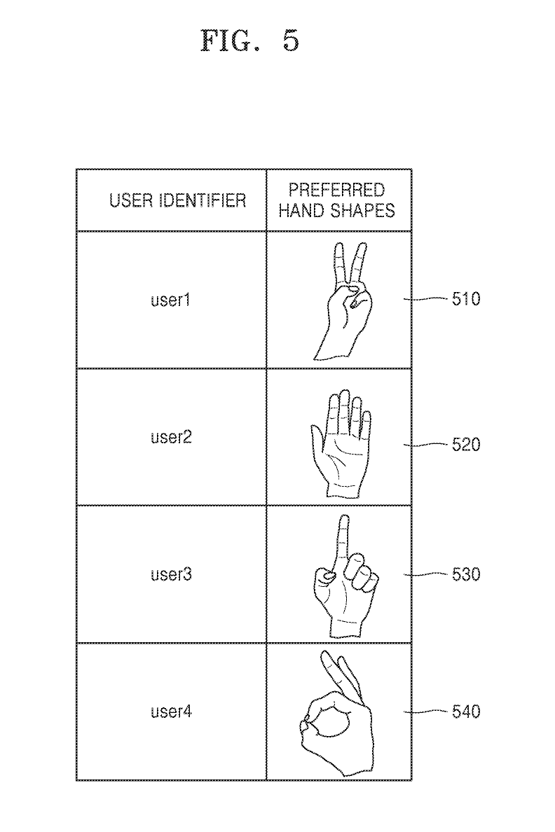

FIG. 5 is a diagram of settings of various hand shapes of each user, according to an embodiment of the present disclosure.

Referring to FIG. 1, the storage unit 130 of the digital camera apparatus 100 may further store user information which includes information about preferred hand shapes of the user. If multiple users use the digital camera apparatus 100, each user may prefer different hand shapes when capturing images. According to the present embodiment, the digital camera apparatus 100 may further include an input unit (not shown) for receiving desired hand shapes of the users from the users, and the controller 120 may store information used to identify each user as well as information about hand shapes registered by the users. Referring to FIG. 5, different hand shapes of the users may be registered. If a first user uses the digital camera apparatus 100, an image may be taken when a ‘V’ gesture 510 is recognized. If a second user uses the digital camera apparatus 100, an image may be taken when an open hand 520, of which five fingers are open, is recognized. If a third user uses the digital camera apparatus 100, an image may be taken when a hand 530, of which only an index finger stands, is recognized, and if a fourth user uses the digital camera apparatus 100, an image may be taken when an “Okay” gesture 540 is recognized.

In order to identify which user uses the digital camera apparatus 100, a method of allowing the various users to sign in the digital camera apparatus 100 by using identifications (IDs) or accounts of the users may be used. However, the method may cause inconvenience to the users who want to capture images. Thus, another method of identifying the users by using facial information of the users, which is acquired by capturing facial images of the users, may be used. The controller 120 receives the facial images of the users, whose images are captured by the capturing unit 110, and may store information about various user faces in the storage unit 130 as user information. The controller 120 identifies the users by using the facial information recognized from the preview image, as well as the facial information about the user faces stored in the storage unit 130 when images are taken, and if a preferred hand shape of the identified user is recognized, the controller 120 may control the capturing unit 110 to capture an image.

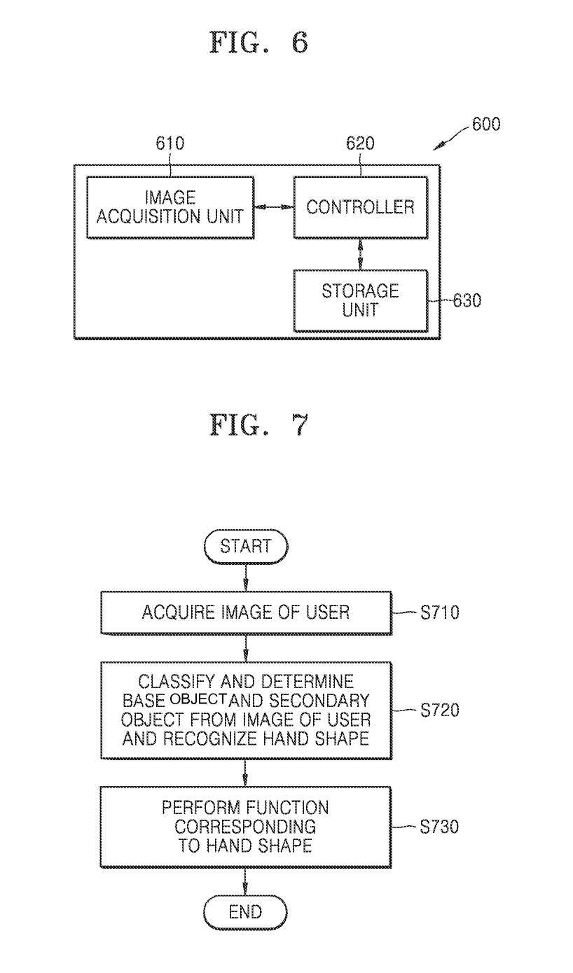

FIG. 6 is a block diagram of a digital apparatus 600 according to an embodiment of the present disclosure.

The digital apparatus 600 performs predetermined functions according to hand shapes of a user and may include an image acquisition unit 610, a controller 620, and a storage unit 630. The digital apparatus 600 may be a computing device including a camera, and examples of the digital apparatus 600 may be a digital camera, a digital game device connected to a camera, an interactive digital device including a camera, a digital advertisement device, and the like.

The image acquisition unit 610 is used to acquire images of the user and may directly capture images of the user. The image acquisition unit 610 may include a capturing unit 110. However, according to another embodiment of the present disclosure, the image acquisition unit 610 may include a reception unit (not shown) which receives images of the user from a camera including a capturing unit 110, or may include a communication unit (not shown) for receiving images of the user from an external digital device.

The controller 620 recognizes hand shapes from the images of the user which are acquired by the image acquisition unit 610, and may be embodied as a processor. The controller 620 may include a classifier (not shown) which may be embodied as software and/or hardware. If one of predetermined hand shapes is recognized, the controller 620 performs a function corresponding to the recognized hand shape. If a function corresponding to the recognized hand shape is image capture, the controller 620 controls the image acquisition unit 610 to capture an image.

Conventional understandings of various hand shapes may differ according to religious or cultural backgrounds. A hand shape that is generally accepted in a certain cultural area may have a very different, possibly offensive, meaning in another cultural area. In addition, according to preference of users, each user might choose to use a different hand shape to control a same function of the digital apparatus 600. Therefore, if a developer or manufacturer of an apparatus determines to use a certain hand shape in order to perform a certain function, users may feel inconvenience. According to an embodiment of the present disclosure, the controller 620 may include an input unit (not shown) for receiving information about functions to be performed and hand shapes corresponding to these functions. In this case, the controller 620 of the digital apparatus 600 may provide the user with a user interface for registering hand shapes through an output unit (not shown), and the registered hand shapes may be stored in the storage unit 630.

If multiple users use one digital apparatus, each user may want to control a different function by using a same preferred hand shape or motion. In order to solve the problem, information about hand shapes and functions corresponding to the hand shapes of each user may be managed. That is, identification information and information about the hand shape and functions corresponding to the hand shape of each user may be stored in the storage unit 630. The identification information and information may be input from the users through the user interface. The identification information of the users may be IDs or account information of the users, but facial information of the users may also be used to solve the user inconvenience caused by an input of ID or signing in. The controller 620 acquires images of the users who want to register the information about the hand shapes through the image acquisition unit 610, generates facial information of the users which is analyzed from the images of the users, and may store the generated facial information in the storage unit 630. The controller 620 may identify a user of the digital apparatus 600 by using the facial information stored in the storage unit 630. The controller 620 compares the facial information stored in the storage unit 630 to facial information included in images in which the users are captured and determines which user is using the digital apparatus 600. Then, if a hand shape which is registered to a user and stored is recognized, the controller 620 performs a functions corresponding to the recognized hand shape.

FIG. 8 is an image for various “Okay” gestures according to an embodiment of the present disclosure.

In the case of hand shapes for making “Okay” gestures such as gestures 810, 820, and 830, the particular hand shapes may be different depending on the person making the hand shape. Although one person makes an “Okay” gesture, hand shapes of the person may differ according to a direction in which the person stands or a situation. In a conventional device, fingertips were recognized in order to recognize an “Okay” gesture, and if a thumb tip of a user touched the tip of an index finger, a hand shape of the user was determined as the “Okay” gesture. However, it is impossible to train a classifier to cover all the possible “Okay” gestures, and thus the hand shapes are often not recognized well in the related art.

According to an embodiment of the present disclosure, the controller 620 uses a part-based approach which recognizes hand shapes by classifying and determining a base object and a secondary object. The part-based approach is an effective method of recognizing a comparatively complicated hand shape such as the “Okay” gesture. The part-based approach is a method of detecting an object by using part-based models that are classified by training. At least one ROI where the secondary object exists according to a size and location of the base object is defined, and a hand shape is recognized by determining at least one from the at least one ROI. The base object is a base part of a complicated hand shape and generally corresponds to a part such as a palm or a fist. The secondary object is a part which configures the complicated hand shape together with the base object, and generally corresponds to fingers. Also, an ROI means an interest region and is used to limit a location of the secondary object in the present disclosure.

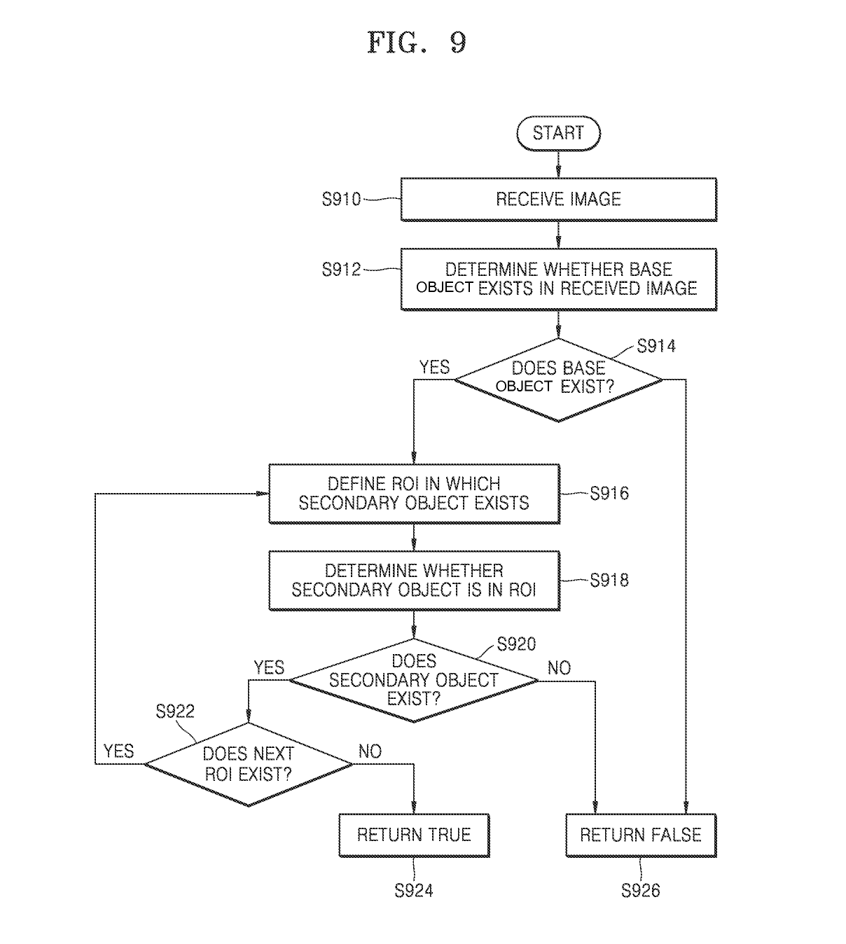

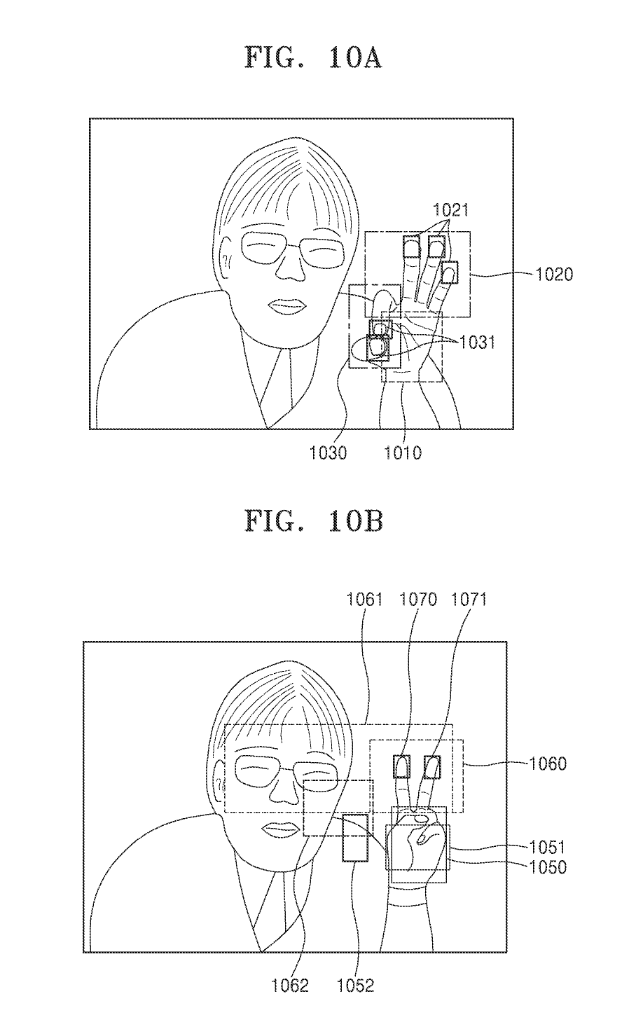

FIG. 9 is a flowchart of a method of recognizing hand shapes according to an embodiment of the present disclosure, and FIG. 10A illustrates a method of recognizing hand shapes according to an embodiment of the present disclosure. Referring to FIG. 10A, the user makes an “Okay” gesture.

First, the image acquired by the image acquisition unit 610 is received in operation S910. The controller 620 compares the image acquired by the image acquisition unit 610 with base models that are trained, and determines whether a base object exists in the image in operation S912. Referring to FIG. 10A, the base model may be a palm model, and the determined base object may be a portion 1010 corresponding to a palm. If the base object is determined to exist in operations S912 and S914, at least one ROI where a secondary object must be located is defined in operation S916 based on a size and location of the base object.

A determination as to whether the secondary object exists in a first ROI is made in operation S918. The first ROI may be an area 1020 where three fingers face upward. The secondary object may be recognized by comparison with a trained secondary model and may be a part corresponding to fingers in FIG. 10A. If no secondary object is determined to exist in the first ROI in operation S920, a hand shape is not recognized, and FALSE is returned in operation S926. Referring to FIG. 10A, three secondary objects 1021 exist in the area 1020 defining the first ROI area 1020. If a secondary object is determined to exist in the first ROI in operation S920, a determination as to whether a next ROI exists is made in operation S922. If the next ROI is determined to exist in operation S922, an operation S916 is re-performed in which the next ROI, where a secondary object must be located, is defined.

A determination as to whether the secondary object exists in a second ROI is made in operation S918. Referring to FIG. 10A, two secondary objects 1031, which in this example are a thumb facing upward and an index finger facing downward, exist in an area 1030 defining the second ROI. If the secondary object that must be located in the second ROI is not determined to exist in operation S920, it is determined that recognition of the hand shape fails, and thus FALSE is returned in operation S926. If the secondary object that must be located in the second ROI is determined to exist in operation S920, a determination is made in operation S922 as to whether a next ROI to be processed exists. If no next ROI is determined to exist, it is determined that the recognition of the hand shape succeeds, and thus TRUE may be returned in operation S924.

In the case of the “Okay” gesture, two ROIs, that is, an area 1020 where three fingers face upward and an area 1030 where a fingertip of a thumb touches that of an index finger, may exist. If a determination requirement is set in which a hand shape may be successfully recognized only when the secondary objects are included in two ROIs, but an image includes only one ROI in which a secondary object exists, it may be determined that the recognition of the hand shape fails, and FALSE may be returned. On the other hand, if a determination requirement is set in which a hand shape may be successfully recognized even if one of the two ROIs includes a secondary object, when an image includes one ROI in which a secondary object is determined to exist, it may be determined that the recognition of the hand shape succeeds, and thus TRUE may be returned.

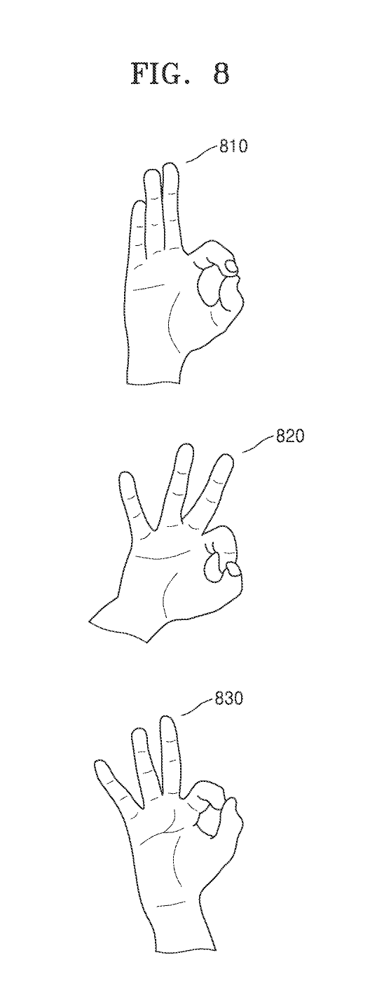

FIG. 7 is a flowchart of a method of controlling a digital apparatus according to an embodiment of the present disclosure.

An image of a user is acquired first in operation S710. The acquired image of the user may be a preview image. A base object and a secondary object are classified and determined from the acquired image, and a hand shape is recognized in operation S720. A determination as to whether a certain hand shape is included in the image of the user may be made based on the above-described part-based approach. If a predetermined hand shape is recognized from the image of the user, a function corresponding to the recognized hand shape may be performed in operation S730.

FIG. 10B illustrates a method of recognizing hand shapes according to another embodiment of the present disclosure. Referring to FIG. 10B, a user makes a ‘V’ gesture.

The classifier may include a base detector for determining a base object and a secondary detector for determining a secondary object. Referring to FIG. 10B, the base detector may detect three base objects 1050, 1051, and 1052. At least one ROI in which a secondary object is located with regard to each of the base objects 1050, 1051, and 1052 is defined. Then, a determination as to whether a secondary object exists in the defined ROI is made, and if recognition of a hand shape succeeds with regard to one or more base objects, it is determined that the recognition of the hand shape succeeds. Referring to FIG. 10B, ROIs 1060, 1061, and 1062 with regard to multiple base objects are defined. Images of fingers, which in this example are two secondary objects 1070 and 1071, are recognized in the ROI 1060 which is defined according to a size and location of the first base object 1050. Based on recognizing the fingers in secondary objects 1070 and 1071, a hand shape of the user is determined as a ‘V’ gesture.

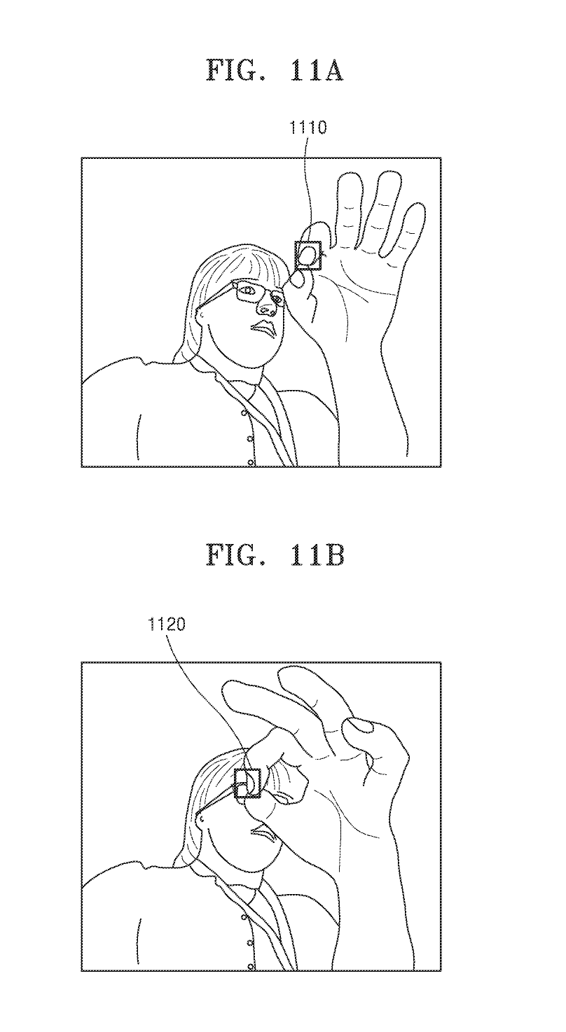

FIGS. 11A and 11B illustrate a method of recognizing “Okay” gestures according to an embodiment of the present disclosure.

A distinct feature of the “Okay” gesture is a circular shape made by a thumb and an index finger, that is, an ‘O’ gesture. However, as shown in FIG. 11A, the “Okay” gesture may have a form in which a nail, that is, a fore part 1110 of the index finger is shown, but as shown in FIG. 11B, the “Okay” gesture may also have a form in which a side part 1120 of the index finger is shown. Two different models may be used in order to improve recognition performance and to recognize the fore part 1110 and side part 1120 of the index finger. Also, if it is determined that the recognition succeeds only when both the thumb and the index finger are recognized, the recognition performance may be degraded. Thus, the classifier may be embodied to recognize an “Okay” gesture even though only one of the thumb and the index finger is recognized.

In addition, other various embodiments of the present disclosure can also be implemented through computer readable code/instructions encoded in/on a non-transitory medium, e.g., a non-transitory computer readable medium, to, when executed, control at least one processing element to implement any above described embodiment. The computer readable medium can correspond to any medium/media permitting the storage and/or transmission of the computer readable code.

The computer readable code can be recorded/transferred on a non-transitory medium in a variety of ways, with examples of the non-transitory medium including recording media, such as magnetic storage media (e.g., Random Access Memory (RAM), Read-Only Memory (ROM), floppy disks, hard disks, etc.) and optical recording media (e.g., Compact Disc (CD)-ROMs, or Digital Versatile Discs (DVDs)), and temporary storage in transmission media such as Internet servers or routers. The media may also be implemented with a distributed network, so that the computer readable code is stored/transferred and executed in a distributed fashion. Furthermore, the processing element could include a processor or a computer processor, and processing elements may be distributed and/or included in a single device.

It should be understood that the various embodiments described therein should be considered in a descriptive sense only and not for purposes of limitation. Descriptions of features or aspects within each embodiment should typically be considered as available for other similar features or aspects in other various embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A digital apparatus comprising:
an image acquisition unit configured to acquire an image of a user; and
a controller configured to recognize a hand shape in the acquired image of the user and to perform a function corresponding to the recognized hand shape.

2. The digital apparatus of claim 1, wherein the recognizing of the hand shape comprises classifying and determining a base object and a secondary object from the acquired image.

3. The digital apparatus of claim 2, wherein the controller defines at least one Region Of Interest (ROI), in which the secondary object is determined to exist, according to a size and a location of the base object, and determines at least one secondary object from the at least one ROI.

4. The digital apparatus of claim 1, wherein the controller controls the image acquisition unit to capture an image when the recognized hand shape comprises a predetermined hand shape.

5. The digital apparatus of claim 1, further comprising an input unit configured to receive, from the user, information associating one or more hand shapes recognizable by the digital apparatus with one or more corresponding functions.

6. The digital apparatus of claim 1, further comprising a storage unit for storing identification information of the user, information about hand shapes associated with the user, and functions corresponding to the hand shapes associated with the user,
wherein the controller identifies the user of the digital apparatus by using the identification information stored in the storage unit.

7. A method of controlling a digital apparatus, the method comprising:
acquiring an image of a user;
recognizing a hand shape in the acquired image of the user; and
performing a function corresponding to the recognized hand shape.

8. The method of claim 7, wherein the recognizing of the hand shape comprises classifying and determining a base object and a secondary object from the acquired image.

9. The method of claim 8, wherein the recognizing of the hand shape comprises:
defining at least one Region Of Interest (ROI), in which the secondary object is determined to exist, according to a size and location of the base object; and
determining at least one secondary object from the at least one ROI.

10. The method of claim 7, wherein the performing of the function comprises controlling a camera to capture an image when the recognized hand shape comprises a predetermined hand shape.

11. The method of claim 7, further comprising receiving, from the user, information associating one or more hand shapes recognizable by the digital apparatus with one or more corresponding functions.

12. The method of claim 7, further comprising:
storing identification information, information about hand shapes, and functions corresponding to the hand shapes, with regard to the user; and
identifying the user of the digital apparatus by using the stored identification information.

13. A non-transitory computer readable medium having embodied thereon a computer program, which when executed by a computer, performs the method of claim 7.

14. A digital camera apparatus comprising:
a capturing unit configured to capture an image; and
a controller configured to recognize a hand shape in a preview image acquired by the capturing unit and to control the capturing unit to capture the image if the recognized hand shape comprises a predetermined hand shape.

15. The digital camera apparatus of claim 14, further comprising a storage unit configured to store user information comprising identification information and information about preferred hand shapes,
wherein the controller identifies a user by using information identified in the preview image and the identification information stored in the storage unit and controls the capturing unit to capture the image when a preferred hand shape of the identified user is recognized.

16. The digital camera apparatus of claim 14, wherein the controller controls the capturing unit to capture the image when a certain amount of time passes after the hand shape is recognized.

17. A method of capturing an image in a digital camera apparatus, the method comprising:
acquiring a preview image;
recognizing a hand shape in the acquired preview image; and
capturing an image if the recognized hand shape comprises a predetermined hand shape.

18. The method of claim 17, further comprising storing user information which comprises identification information and information about a preferred hand shape,
wherein the capturing of the image comprises:
identifying a user of the digital camera apparatus by using identification information recognized in the preview image and the stored identification information; and
capturing the image if a preferred hand shape of the identified user is recognized.

19. The method of claim 18, wherein the capturing comprises capturing the image when a certain amount of time passes after the hand shape is recognized.

20. A non-transitory computer readable medium having embodied thereon a computer program, which when executed by a computer, performs the method of claim 17.
